(19) United States
(12) Patent Application Publication
(10) Pub. No.: US 2019/0095724 A1
(43) Pub. Date: Mar. 28, 2019

(54) SURROUNDINGS MONITORING DEVICE, SURROUNDINGS MONITORING METHOD, AND STORAGE MEDIUM

(71) Applicant: HONDA MOTOR CO., LTD., Tokyo (JP)

(72) Inventors: Yugo Ueda, Wako-shi (JP); Katsuaki Sasaki, Wako-shi (JP); Akihiro Toda, Wako-shi (JP)

(21) Appl. No.: 16/136,356

(22) Filed: Sep. 20, 2018

(30) Foreign Application Priority Data
Sep. 26, 2017 (JP) 2017-184800

(51) Int. Cl. G06K 9/00; G06T 7/20; G05D 1/00

(52) U.S. Cl. CPC G06K 9/00798; G06T 7/20; G05D 2201/0213; G06T 2207/30256; G05D 1/0088

(57) ABSTRACT

A surroundings monitoring device includes a median strip determination unit that determines whether or not there is a median strip in a road around a vehicle, and a progression direction estimation unit that estimates that a plurality of lanes in front of the median strip in a case that viewed from the vehicle among lanes included in a crossroad crossing a road on which the vehicle is traveling are lanes in the same progression direction in a case that the vehicle reaches the crossroad and the median strip determination unit determines that there is the median strip in the crossroad.

### CROSS-REFERENCE TO RELATED APPLICATION

Priority is claimed on Japanese Patent Application No. 2017-184800, filed Sep. 26, 2017, the content of which is incorporated herein by reference.

### BACKGROUND OF THE INVENTION

### Field of the Invention

The present invention relates to a surroundings monitoring device, a surroundings monitoring method, and a storage medium.

### Description of Related Art

In recent years, research on automatic control of a vehicle has been performed. In relation thereto, a technology for determining a progression direction in a plurality of lanes separated by a median strip in a case that there are the plurality of lanes in a road crossing a progression direction of a subject vehicle during automatic driving is known (For example, see Japanese Unexamined Patent Application, First Publication No. 2005-267470).

### SUMMARY OF THE INVENTION

However, the related art is not an art for detecting a median strip and determining a progression direction in a plurality of lanes in a case that there are a plurality of lanes separated by a median strip in a road crossing the progression direction of a subject vehicle.

The present invention has been made in consideration of such circumstances, and an object of the present invention is to provide a surroundings monitoring device, a surroundings monitoring method, and a storage medium capable of easily estimating a progression direction of a plurality of lanes crossing at a crossing by detecting a median strip.

A surroundings monitoring device, a surroundings monitoring method, and a storage medium according to the present invention adopt the following configuration.

(1) A surroundings monitoring device according to an aspect of the present invention is a surroundings monitoring device including: a median strip determination unit that determines whether or not there is a median strip in a road near a vehicle; and a progression direction estimation unit that estimates that a plurality of lanes in front of the median strip in a case that viewed from the vehicle among lanes included in a crossroad crossing a road on which the vehicle is traveling are lanes in the same progression direction in a case that the vehicle reaches the crossroad and the median strip determination unit determines that there is the median strip in the crossroad.

(2) In the surroundings monitoring device according to (1), the median strip determination unit further determines whether or not there is a section of the median strip of the crossroad in front of the vehicle, and the surroundings monitoring device further includes a progression possibility determination unit that determines that progression in a direction opposite to the same progression direction in the crossroad behind the median strip is possible in a case that the median strip determination unit determines that there is a section of the median strip of the crossroad in front of the vehicle.

(3) In the surroundings monitoring device according to (1), the median strip determination unit further determines whether or not there is a section of the median strip of the crossroad in front of the vehicle, and the surroundings monitoring device further includes a progression possibility determination unit that determines that progression in the same progression direction in the crossroad in front of the median strip is possible in a case that the median strip determination unit determines that there is a section of the median strip of the crossroad in front of the vehicle.

(4) In the surroundings monitoring device according to (2), the median strip determination unit determines that there is a section of the median strip in a case that the median strip determination unit recognizes two end portions of the median strip that are spaced a predetermined distance or more from each other.

(5) In the surroundings monitoring device according to (4), the median strip determination unit determines that there is a section of the median strip in a case that the distance between the two end portions is equal to or greater than a width of a vehicle serving as a reference.

(6) In the surroundings monitoring device according to (1), the progression direction estimation unit increases certainty that the plurality of lanes in front of the median strip in a case that viewed from the vehicle are lanes in the same progression direction on the basis of the progression direction of other vehicles traveling in the plurality of lanes in front of the median strip in a case that viewed from the vehicle.

(7) A surroundings monitoring method that is executed by a computer mounted in a vehicle is a surroundings monitoring method including: determining whether or not there is a median strip in a road near a vehicle; and estimating that a plurality of lanes in front of the median strip in a case that viewed from the vehicle among lanes included in a crossroad crossing a road on which the vehicle is traveling are lanes in the same progression direction in a case that the vehicle reaches the crossroad and it is determined that there is the median strip in the crossroad.

(8) A computer-readable non-transitory storage medium storing a program is a program causing a computer installed in a vehicle to: determine whether or not there is a median strip in a road near a vehicle; and estimate that a plurality of lanes in front of the median strip in a case that viewed from the vehicle among lanes included in a crossroad crossing a road on which the vehicle is traveling are lanes in the same progression direction in a case that the vehicle reaches the crossroad and it is determined that there is the median strip in the crossroad.

According to the above aspects (1), (7), and (8), it is possible to easily estimate the progression direction of the plurality of lanes crossing at the crossing by detecting the median strip.

According to the above aspects (2), (3), (4) and (5), it is possible to determine the progression direction of a plurality of lanes at a crossing at which there is a median strip, and prevent the subject vehicle from reversely traveling on the lane after the subject vehicle turns right or left.

According to the aspect (6), it is possible to increase certainty of the determination of the progression direction of the plurality of lanes at the crossing at which there is the median strip and to reduce a time taken for a recognition process.

### BRIEF DESCRIPTION OF THE DRAWINGS

FIG. 1 is a configuration diagram of a vehicle system 1 using a surroundings monitoring device according to an embodiment.

FIG. 2 is a functional configuration diagram of a first control unit 120 and a second control unit 160.

FIG. 3 is a diagram illustrating an example of a crossing at which there is a median strip D.

FIG. 4 is a diagram illustrating a progression direction of a T-shaped road at which there is the median strip D.

FIG. 5 is a flowchart showing an example of a flow of a process that is executed in an automatic driving control device 100.

FIG. 6 is a diagram illustrating a plurality of configurations that can be used in the automatic driving control device 100.

### DETAILED DESCRIPTION OF THE INVENTION

Hereinafter, embodiments of a surroundings monitoring device, a surroundings monitoring method, and a storage medium according to the present invention will be described with reference to the drawings.

### [Overall Configuration]

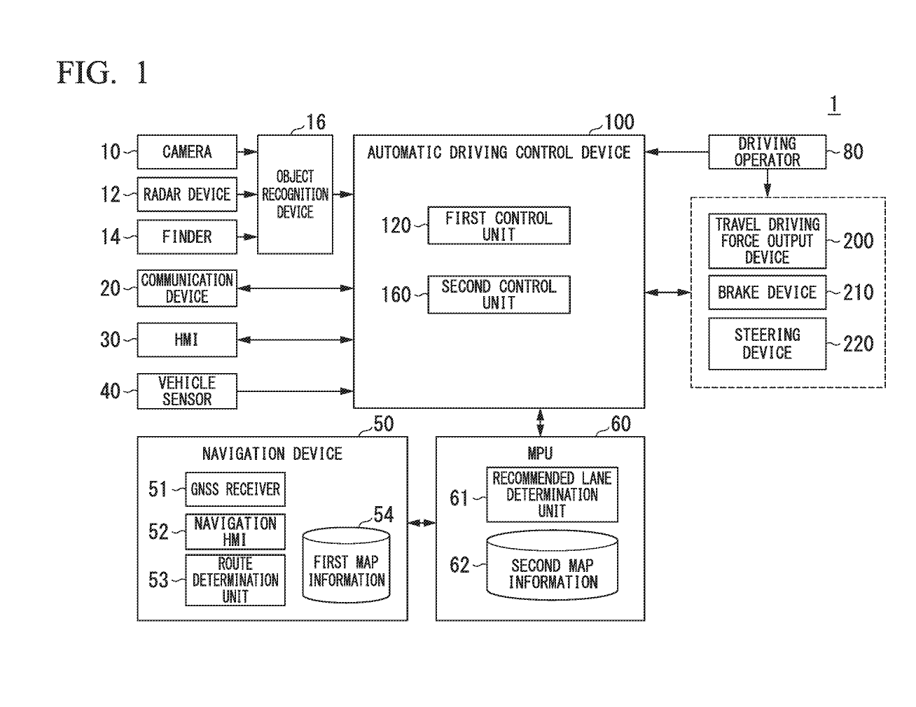

FIG. 1 is a configuration diagram of a vehicle system 1 using a surroundings monitoring device according to an embodiment. A vehicle in which the vehicle system 1 is mounted is, for example, a vehicle such as a two-wheeled, three-wheeled, or four-wheeled vehicle. A driving source thereof is an internal combustion engine such as a diesel engine or a gasoline engine, an electric motor, or a combination thereof. In a case that the electric motor is used, the electric motor is operated using power generated by a generator connected to an internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automatic driving control device 100, a travel driving force output device 200, a brake device 210, and a steering device 220. The apparatuses or devices are connected to each other by a multiplex communication line such as a controller area network (CAN) communication line, a serial communication line, a wireless communication network, or the like. The configuration illustrated in FIG. 1 is merely an example, and a part of the configuration may be omitted, or other configurations may be added.

The camera 10 is, for example, a digital camera using a solid-state imaging element such as a charge coupled device (CCD) or a complementary metal oxide semiconductor (CMOS). One or a plurality of cameras 10 are attached to any places on a vehicle in which the vehicle system 1 is mounted (hereinafter referred to as a subject vehicle M). In the case of forward imaging, the camera 10 is attached to an upper portion of a front windshield, a rear surface of a rearview mirror, or the like. The camera 10, for example, periodically repeatedly images the surroundings of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (distance and orientation) of the object. One or a plurality of radar devices 12 are attached to any places on the subject vehicle M. The radar device 12 may detect a position and a speed of an object using a frequency modulated continuous wave (FM-CW) scheme.

The finder 14 is a light detection and ranging (LIDAR). The finder 14 radiates light around the subject vehicle M and measures scattered light. The finder 14 detects a distance to a target on the basis of a time from light emission to light reception. The radiated light is, for example, pulsed laser light. One or a plurality of finders 14 are attached to any places on the subject vehicle M.

The object recognition device 16 performs a sensor fusion process on detection results of some or all of the camera 10, the radar device 12, and the finder 14 to recognize a position, type, speed, and the like of an object. The object recognition device 16 outputs recognition results to the automatic driving control device 100. The object recognition device 16 may output the detection results of the camera 10, the radar device 12, or the finder 14 to the automatic driving control device 100 as they are according to necessity.

The communication device 20, for example, communicates with another vehicle near the subject vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the subject vehicle M and receives an input operation from the occupant. The HMI 30 includes various display devices, speakers, buzzers, a touch panel, switches, keys, and the like.

The vehicle sensor 40 includes, for example, a vehicle speed sensor that detects a speed of the subject vehicle M, an acceleration sensor that detects an acceleration, a yaw rate sensor that detects an angular speed around a vertical axis, and an orientation sensor that detects a direction of the subject vehicle M.

The navigation device 50 includes, for example, a global navigation satellite system (GNSS) receiver 51, a navigation HMI 52, and a route determination unit 53, and holds first map information 54 in a storage device such as a hard disk drive (HDD) or a flash memory. The GNSS receiver 51 specifies a position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determination unit 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route determined by the route determination unit 53 is output to the MPU 60. The navigation device 50 may perform route guidance using the navigation HMI 52 on the basis of the on-map route determined by the route determination unit 53. The navigation device 50 may be realized, for example, by a function of a terminal device such as a smartphone or a tablet terminal possessed by the occupant. The navigation device 50 may transmit a current position and a destination to a navigation server via the communication device 20 and acquire the on-map route with which the navigation server replies.

The MPU 60, for example, functions as a recommended lane determination unit 61, and holds second map information 62 in a storage device such as an HDD or a flash memory. The recommended lane determination unit 61 divides the route provided from the navigation device 50 into a plurality of blocks (for example, divides the route every 100 [m] in a progression direction of the vehicle), and determines a recommended lane for each block by referring to the second map information 62. The recommended lane determination unit 61 determines in which lane from the left the subject vehicle M travels. The recommended lane determination unit 61 determines the recommended lane so that the subject vehicle M can travel on a reasonable route for traveling to a branch destination in a case that there are branching points, merging points, or the like in the route.

The second map information 62 is map information with higher accuracy than the first map information 54. The second map information 62 includes, for example, information on a center of the lane or information on a boundary of the lane. The second map information 62 may include road information, traffic regulation information, address information (address and postal code), facility information, telephone number information, and the like. The second map information 62 may be updated at any time by accessing another device using the communication device 20.

The driving operator 80 includes, for example, an accelerator pedal, a brake pedal, a shift lever, a steering wheel, a modified steering wheel, a joystick, and other operators. A sensor that detects the amount of operation or the presence or absence of the operation is attached to the driving operator 80, and a result of the detection is output to some or all of the automatic driving control device 100, the travel driving force output device 200, the brake device 210, and the steering device 220.

The automatic driving control device 100 includes, for example, a first control unit 120, and a second control unit 160. Each of the first control unit 120 and the second control unit 160 is realized, for example, by a hardware processor such as a central processing unit (CPU) executing a program (software). Some or all of such components may be realized by hardware (including circuitry) such as a large scale integration (LSI), an application specific integrated circuit (ASIC), a field-programmable gate array (FPGA), or a graphics processing unit (GPU) or may be realized by software and hardware in cooperation.

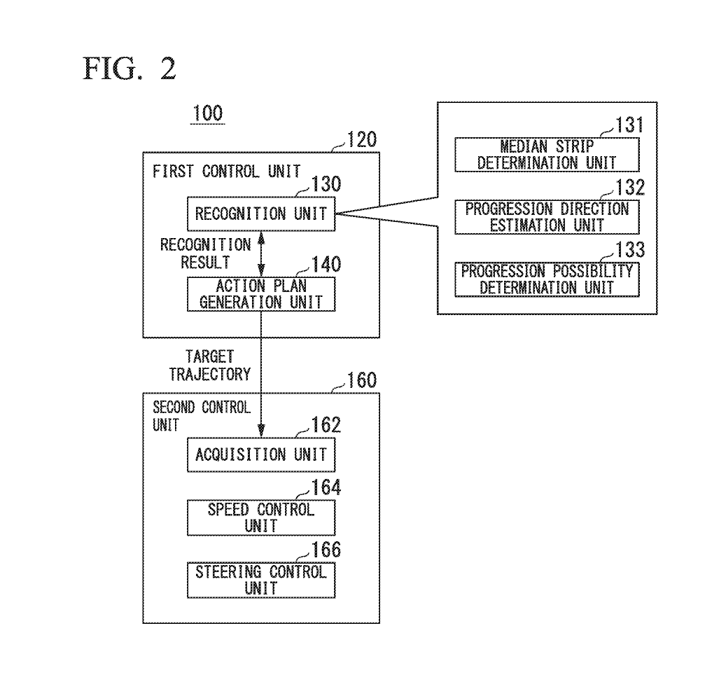

FIG. 2 is a functional configuration diagram of the first control unit 120 and the second control unit 160. The first control unit 120 includes, for example, a recognition unit 130 and an action plan generation unit 140. The first control unit 120 realizes, for example, a function based on artificial intelligence (AI) and a function based on a previously given model in parallel. For example, in a function of “recognizing a crossing,” recognition of a crossing using deep learning or the like and recognition based on previously given conditions (a signal which can be subjected to pattern matching, a road sign, or the like) are executed in parallel, and the function is realized by scoring both recognitions and comprehensively evaluating the recognitions. Accordingly, the reliability of automatic driving is guaranteed.

The recognition unit 130 recognizes a position and a state such as a speed or an acceleration of an object near the subject vehicle M on the basis of information input from the camera 10, the radar device 12, and the finder 14 via the object recognition device 16. The position of the object is recognized, for example, as a position based on absolute coordinates with a representative point (for example, a centroid or a driving axis center) of the subject vehicle M as an origin, and is used for control. The position of the object may be represented by a representative point such as a centroid or a corner of the object or may be represented by an indicated area. The “state” of the object may include an acceleration or jerk of the object, or an “action state” (for example, whether or not the object is changing lanes or is about to change lanes). The recognition unit 130 recognizes a shape of a curve that the subject vehicle M is about to pass on the basis of a captured image of the camera 10. The recognition unit 130 converts the shape of the curve from the captured image of the camera 10 to a real plane and outputs, for example, two-dimensional point sequence information or information represented by using a model equivalent thereto to the action plan generation unit 140 as information indicating the shape of the curve.

The recognition unit 130 recognizes, for example, a lane (traveling lane) in which the subject vehicle M is traveling. For example, the recognition unit 130 compares a pattern of a road marking line (for example, an arrangement of a solid line and a broken line) obtained from the second map information 62 with a pattern of a road marking line near the subject vehicle M recognized from the image captured by the camera 10 to recognize the traveling lane. It should be noted that the recognition unit 130 may recognize not only the road marking line but also a traveling road boundary (road boundary) including the road marking line, a road shoulder, a curb, a median strip, a guard rail, or the like to recognize the traveling lane. In this recognition, the position of the subject vehicle M acquired from the navigation device 50 or a processing result of an INS may be added. The recognition unit 130 recognizes a temporary stop line, an obstacle, a red light, a toll gate, a median strip, and other road events.

The recognition unit 130 recognizes a position or a posture of the subject vehicle M relative to the traveling lane in a case that recognizing the traveling lane. The recognition unit 130 may recognize, for example, a deviation of a reference point of the subject vehicle M from a center of the lane, and an angle formed with respect to a line connecting a center of a lane in a progression direction of the subject vehicle M as a relative position and a posture of the subject vehicle M with respect to the traveling lane. Instead, the recognition unit 130 may recognize, for example, a position of the reference point of the subject vehicle M with respect to any one of side end portions (the road marking line or the road boundary) of the traveling lane as the relative position of the subject vehicle M with respect to the traveling lane.

The recognition unit 130 may derive recognition accuracy in the above recognition process and output recognition accuracy as the recognition accuracy information to the action plan generation unit 140. For example, the recognition unit 130 generates the recognition accuracy information on the basis of a frequency of recognition of the road marking lines in a certain period.

Functions of a median strip determination unit 131, a progression direction estimation unit 132, and a progression possibility determination unit 133 included in the recognition unit 130 will be described below.

In principle, the action plan generation unit 140 determines events to be sequentially executed in the automatic driving so that the subject vehicle M travels in the recommended lane determined by the recommended lane determination unit 61 and copes with a surrounding situation of the subject vehicle M. Examples of the events include a constant speed traveling event in which a vehicle travels on the same traveling lane at a constant speed, a following driving event in which a vehicle follows a preceding vehicle, an overtaking event in which a vehicle overtakes a preceding vehicle, an avoidance event for performing braking and/or steering for avoiding approaching an obstacle, a curve traveling event for traveling at a curve, a passing event for passing through a predetermined point such as a crossing, a crosswalk, or a railway crossing (including a right or left turning event), a lane changing event, a merging event, a branching event, an automatic stop event, and a takeover event for ending automatic driving and switching to manual driving.

The action plan generation unit 140 generates a target trajectory along which the subject vehicle M will travel in the future according to an activated event. Details of each functional unit will be described below. The target trajectory includes, for example, a speed element. For example, the target trajectory is represented as a sequence of points (trajectory points) to be reached by the subject vehicle M. The trajectory point is a point that the subject vehicle M is to reach for each predetermined travel distance (for example, several meters) at a road distance, and a target speed and a target acceleration at every predetermined sampling time (for example, several tenths of a [sec]) are separately generated as part of the target trajectory. The trajectory point may be a position that the subject vehicle M is to reach at the sampling time at every predetermined sampling time. In this case, information on the target speed or the target acceleration is represented by the interval between the trajectory points.

The second control unit 160 controls the travel driving force output device 200, the brake device 210, and the steering device 220 so that the subject vehicle M passes through the target trajectory generated by the action plan generation unit 140 at a scheduled time.

Referring back to FIG. 2, the second control unit 160 includes, for example, an acquisition unit 162, a speed control unit 164, and a steering control unit 166. The acquisition unit 162 acquires information on the target trajectory (track points) generated by the action plan generation unit 140 and stores the information on the target trajectory in a memory (not illustrated). The speed control unit 164 controls the travel driving force output device 200 or the brake device 210 on the basis of the speed element incidental to the target trajectory stored in the memory. The steering control unit 166 controls the steering device 220 according to a degree of bend of the target trajectory stored in the memory. Processes of the speed control unit 164 and the steering control unit 166 are realized by, for example, a combination of feedforward control and feedback control. For example, the steering control unit 166 executes a combination of feedforward control according to a curvature of a road in front of the subject vehicle M and feedback control based on a deviation from the target trajectory.

The travel driving force output device 200 outputs a travel driving force (torque) for traveling of the subject vehicle M to the driving wheels. The travel driving force output device 200 includes, for example, a combination with an internal combustion engine, an electric motor, a transmission, and the like, and an ECU that controls these. The ECU controls the above configuration according to information input from the second control unit 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second control unit 160 or information input from the driving operator 80 so that a brake torque corresponding to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the second control unit 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second control unit 160 or information input from the driving operator 80 to change the direction of the steerable wheels.

### [Recognition of Median Strip]

Next, the content of a process recognized by the recognition unit 130 will be described.

The recognition unit 130 includes, for example, the median strip determination unit 131, the progression direction estimation unit 132, and the progression possibility determination unit 133 (see FIG. 2). A combination of the median strip determination unit 131, the progression direction estimation unit 132, and the progression possibility determination unit 133 is an example of the surroundings monitoring device.

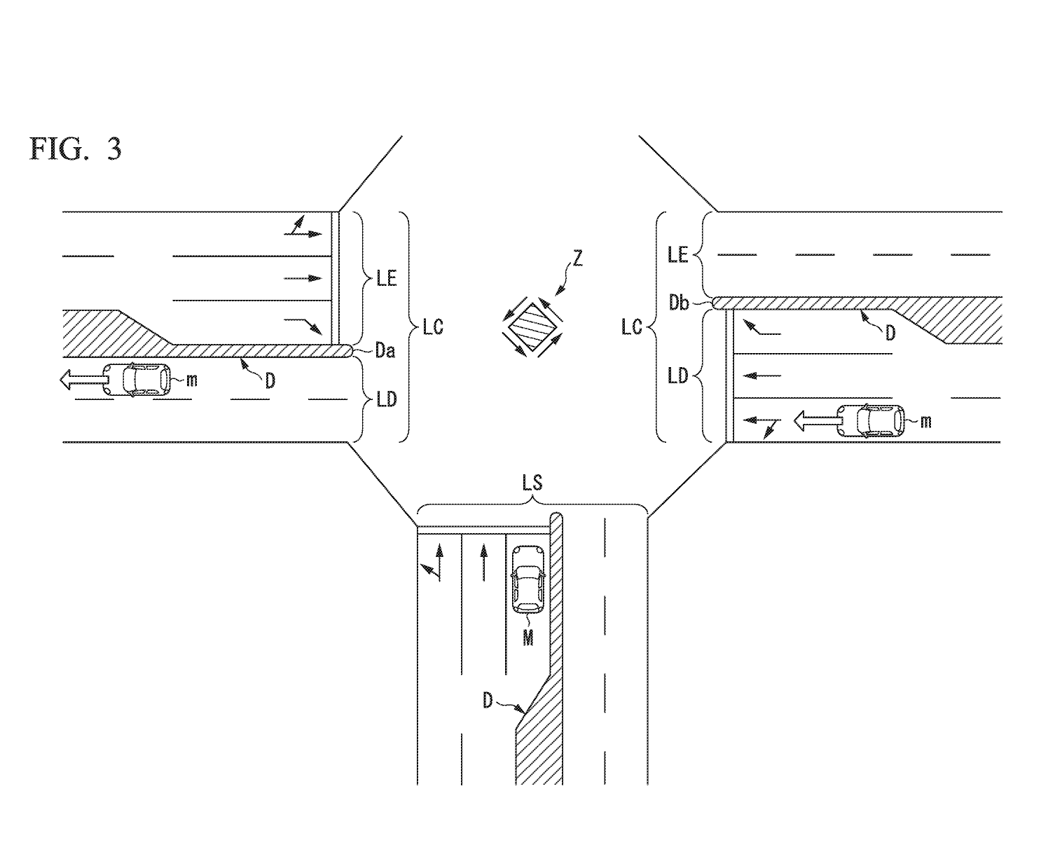

FIG. 3 is a diagram illustrating an example of a crossing at which there is the median strip D. In a case that a plurality of lanes are separated by the median strip D, a plurality of separated lanes on one side and a plurality of separated lanes on the other side are one-way lanes. Hereinafter, a case in which a left-hand traffic regulation is applied will be described. In a road to which a right-hand traffic regulation is applied, left and right in the following description are reversed.

The median strip D is a road facility provided on a road to obstruct the entry of vehicles. Examples of the median strip D includes a structure continuously formed by a block, a curb, a guard rail, or a barrier, a structure provided at predetermined intervals such as poles or trees, and a space (zebra zone) surrounded by a white line indicating entry prohibition. However, it is assumed that a lane marking line such as a mere white line separating a lane and a lane is not included in the median strip D.

The action plan generation unit 140 activates a right or left turn event in a case that the subject vehicle M is located at a predetermined distance before the crossing at which the subject vehicle M is going to perform the right turn or the left turn on the basis of route guidance of the navigation device 50. In a case that the action plan generation unit 140 activates the right or left turn event, the action plan generation unit 140 requests the median strip determination unit 131 or the like to perform a process.

The median strip determination unit 131 receives the request and starts a process of determining whether or not there is a median strip D of a road LS around the subject vehicle M. For example, in a case that the subject vehicle M reaches a crossroad LC crossing the road LS on which the subject vehicle M is traveling, the median strip determination unit 131 determines whether or not there is a median strip D in the crossroad LC crossing the road LS on the basis of a recognition result of the object recognition device 16.

For example, in a case that the object recognition device 16 has recognized the median strip D installed in the crossroad LC crossing the road LS, the median strip determination unit 131 determines that there is the median strip D in the crossroad LC.

In a case that the median strip determination unit 131 has determined that there is the median strip D in the crossroad LC, the median strip determination unit 131 determines whether or not there is a section of the median strip D. The median strip determination unit 131 determines, for example, whether or not there is a section of the median strip D by recognizing end portions of the median strip D on the basis of the recognition result of the object recognition device 16. In a case that a distance between two end portions of the median strip which are spaced from each other is equal to or greater than a width of a vehicle serving as a reference, the median strip determination unit 131 determines that there is a section of the median strip with a width through which the subject vehicle M can pass. The width of the vehicle serving as a reference is a distance with reference to a width of the subject vehicle M. Alternatively, the width of the vehicle serving as a reference may be a fixed value with reference to a width of a sufficiently large vehicle.

The median strip determination unit 131 determines, for example, that there is not a section of the median strip D in a case that the end portions of the median strip D cannot be recognized on the basis of the recognition result of the object recognition device 16. The median strip determination unit 131 outputs a result of the determination to the progression direction estimation unit 132.

In addition, the median strip determination unit 131 may perform a determination process regarding the median strip D by referring to information stored in the second map information 62.

The progression direction estimation unit 132 determines a progression direction of the lane included in the crossroad LC on the basis of the determination result of the median strip determination unit 131. The progression direction estimation unit 132 prevents the subject vehicle M from reversely traveling by determining the progression direction of the lane included in the crossroad LC.

In a case that the subject vehicle M reaches the crossroad LC and the median strip determination unit 131 determines that there is the median strip D in the crossroad LC, the progression direction estimation unit 132 estimates that a plurality of lanes in front of the median strip D in a case that viewed from the subject vehicle M among lanes included in the crossroad LC are lanes in the same progression direction.

In a case that the subject vehicle M reaches the crossroad LC and the median strip determination unit 131 determines that there is the median strip D in the crossroad LC, the progression direction estimation unit 132 estimates that a plurality of lanes behind the median strip D in a case that viewed from the subject vehicle M among the lanes included in the crossroad LC are lanes in a progression direction opposite to the progression direction of the plurality of lanes in front.

The progression direction estimation unit 132 determines, for example, that the progression direction of the plurality of lanes in front of the median strip D in a case that viewed from the subject vehicle M is a left direction on the basis of the recognition result of the median strip determination unit 131 in a case that the subject vehicle M has reached the crossroad LC such as a T-shaped road at which there is a median strip D that there is not a section.

The progression direction estimation unit 132 may add a determination as to a progression direction of other vehicles m traveling on a plurality of lanes LD in front of the median strip in a case that viewed from the subject vehicle, thereby increasing certainty that the plurality of lanes LD in front of the median strip D in a case that viewed from the subject vehicle M are the lanes in the same progression direction. The progression direction estimation unit 132 estimates, for example, the progression direction of the plurality of lanes on the basis of a result of recognizing a progression direction of the other vehicles m recognized by the object recognition device 16.

In addition, the progression direction estimation unit 132 may add information on lanes stored in the second map information 62 or add a result of recognizing a guidance indication Z or the like in the progression direction within the crossing, thereby further increasing the certainty of the progression direction of the lane.

For example, in a state in which the certainty is high, the action plan generation unit 140 reduces a time taken for a recognition process of the recognition unit 130 and advances a timing at which the subject vehicle M is started. However, in a state in which the certainty is low, the action plan generation unit 140 lengthens a continuous standby time of the recognition process of the recognition unit 130.

The progression possibility determination unit 133 determines whether or not progression to the plurality of lanes included in the crossroad LC is possible and a direction in which the progression is possible on the basis of the determination result of the progression direction estimation unit 132. For example, the progression possibility determination unit 133 determines whether or not progression to all the lanes of the crossroad LC is possible in a case that the median strip determination unit 131 determines that there is a section of the median strip D of the crossroad LC in front of the subject vehicle M. Further, on the basis of a result of the determination of the progression direction estimation unit 132, the progression possibility determination unit 133 determines that progression to the left is possible on the plurality of lanes LD in front of the median strip D in a case that viewed from the subject vehicle M and determines that progression to the right is possible on a plurality of lanes LE behind the median strip D in a case that viewed from the subject vehicle M.

However, in a case that the median strip determination unit 131 determines that there is not a section of the median strip D of the crossroad LC in front of the subject vehicle M, the progression possibility determination unit 133 determines that progression to the plurality of lanes LD in front of the median strip D of the crossroad LC in a case that viewed from the subject vehicle M is possible, but progression to the plurality of lanes LE behind the median strip D in a case that viewed from the subject vehicle M is not possible. Further, the progression possibility determination unit 133 determines that the progression to the left is possible on the plurality of lanes LD in front of the median strip D in a case that viewed from the subject vehicle M on the basis of the determination result of the progression direction estimation unit 132.

The progression possibility determination unit 133 outputs the determination result to the action plan generation unit 140. The action plan generation unit 140 generates a target trajectory to a lane to which the subject vehicle M is to travel for a right or left turn on the basis of the determination result of the progression possibility determination unit 133. The speed control unit 164 and the steering control unit 166 control the travel driving force output device 200, the brake device 210, and the steering device 220 on the basis of information on the target trajectory for a right turn or a left turn generated by the action plan generation unit 140 so that the subject vehicle M travels to a lane to travel.

In the example of FIG. 3, the median strip determination unit 131 determines that there is the median strip D in the crossroad LC crossing the road LS on which the subject vehicle M is traveling. The median strip determination unit 131 determines that there is a section of the median strip D by recognizing two end portions Da and Db. For example, the median strip determination unit 131 determines that the two end portions Da and Db are spaced from each other by a distance equal to or greater than a width of the vehicle serving as a reference by recognizing the two end portions Da and Db in the median strip D.

For example, the progression direction estimation unit 132 determines that the progression direction of the plurality of lanes LD in front of the median strip D in a case that viewed from the subject vehicle M at the crossroad LC is a left direction. The progression direction estimation unit 132 determines that the progression direction of the plurality of lanes LE behind the median strip D in a case that viewed from the subject vehicle M at the crossroad LC is a right direction.

By performing the determination process as described above, in a case that the subject vehicle M is going to turn right, the subject vehicle M progresses to the plurality of lanes LE behind the median strip D at the crossroad LC at which there is a section of the median strip D in front of the subject vehicle M. That is, in a case that the subject vehicle M is going to turn right, the subject vehicle M does not progress to the plurality of lanes LD in front of the median strip D and does not reversely travel to a one-way traffic lane at the crossroad LC at which there is a section of the median strip D at the front of the subject vehicle M. Similarly, in a case that the subject vehicle M is going to turn left, the subject vehicle M progresses to the plurality of lanes LD in front of the median strip D at the crossroad LC at which there is a section of the median strip D in front of the subject vehicle M. That is, in a case that the subject vehicle M is going to turn left, the subject vehicle M does not progress to the plurality of lanes LE behind the median strip D and does not reversely travel to a one-way traffic lane at the crossroad LC at which there is a section of the median strip D at the front of the subject vehicle M.

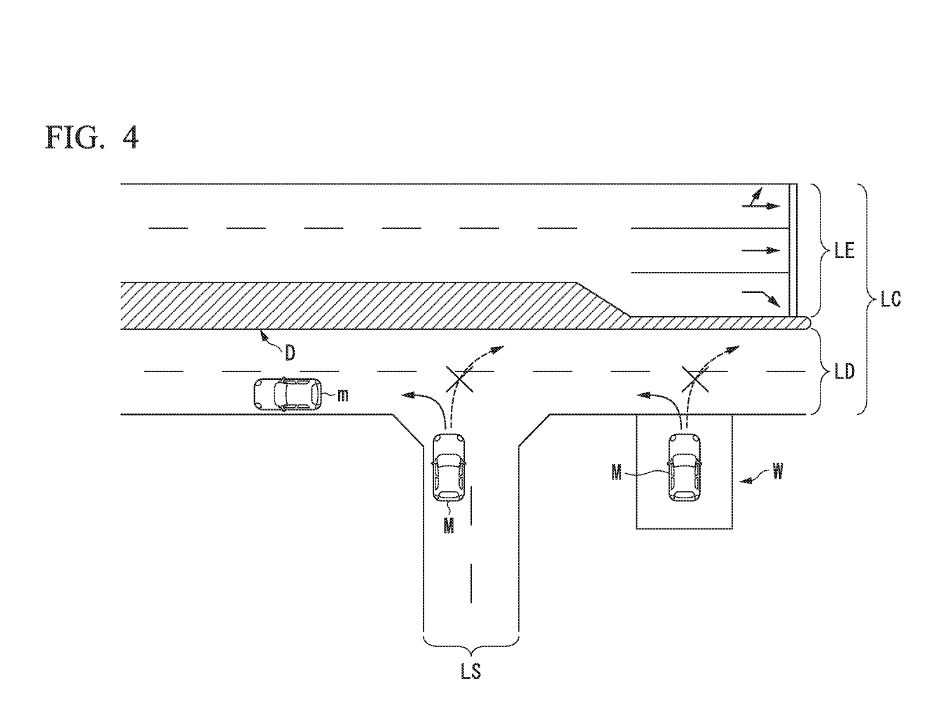

FIG. 4 is a diagram illustrating a progression direction of a T-junction at which there is the median strip D.

In an example of FIG. 4, the median strip determination unit 131 determines that there is a median strip D on the basis of the recognition result of the object recognition device 16. The median strip determination unit 131 determines, for example, that an end portion of the median strip D is not recognized and there is a section of the median strip D on the basis of the recognition result of the object recognition device 16.

The progression direction estimation unit 132 estimates, for example, that a progression direction of a plurality of lanes LD in front of the median strip D in a case that viewed from the subject vehicle M is a left direction on the basis of the recognition result of the median strip determination unit 131.

The progression direction estimation unit 132 may determine, for example, that the progression direction of the plurality of lanes LD in front of the median strip D in a case that viewed from the subject vehicle M is a left direction on the basis of the recognition result of the median strip determination unit 131 even in a case that the subject vehicle M comes out from a site W adjacent to the plurality of lanes LD to the plurality of lanes LD.

By performing the determination process as described above, the subject vehicle M does not turn right to the plurality of lanes LD in front of the median strip D, progresses to the left, and does not perform reverse traveling to a one-way traffic lane at the crossroad LC where there is a section of the median strip D in front of the subject vehicle M.

### [Process Flow]

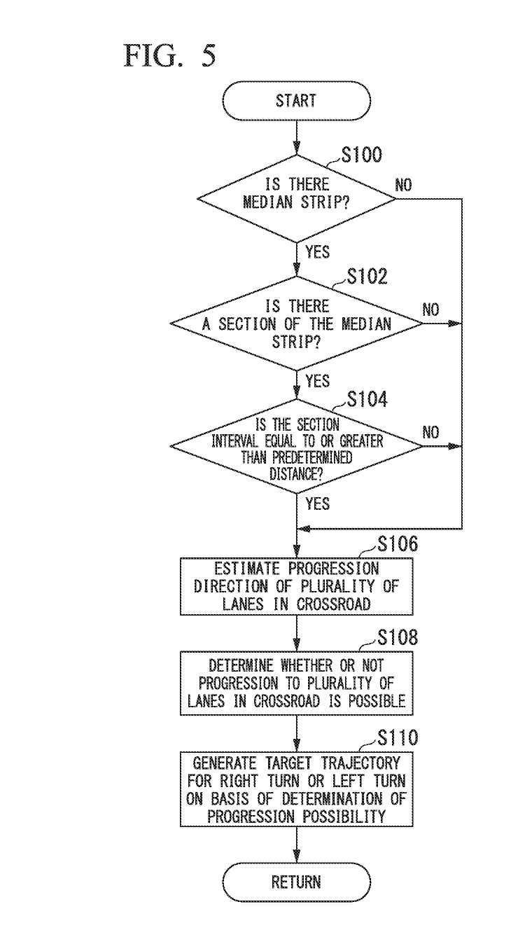

Next, a flow of a process to be executed in the automatic driving control device 100 will be described. FIG. 5 is a flowchart showing an example of a flow of a process to be executed in the automatic driving control device 100.

In a case that the subject vehicle M reaches the crossroad LC crossing the road LS on which the subject vehicle M is traveling, the median strip determination unit 131 determines whether or there is a median strip D in the crossroad LC on the basis of the recognition result of the object recognition device 16 (step S100).

In a case that the median strip determination unit 131 has determined that there is the median strip D in the crossroad LC, the median strip determination unit 131 determines whether or not there is a section of the median strip D (step S102). In a case that the median strip determination unit 131 has determined that there is no median strip D in the crossroad LC, the median strip determination unit 131 proceeds to a process of step S106. In a case that the median strip determination unit 131 has determined that there is a section of the median strip D, the median strip determination unit 131 determines whether a section interval of the median strip D is equal to or greater than the width of the vehicle serving as a reference (step S104).

In a case that the median strip determination unit 131 has determined that the section interval of the median strip D is equal to or greater than a predetermined distance, the median strip determination unit 131 determines that there is a section of the median strip D with a width through which the subject vehicle M can pass. In a case that the median strip determination unit 131 has determined that the section interval of the median strip D is smaller than the predetermined distance, the median strip determination unit 131 determines that the subject vehicle M cannot pass through the width and proceeds to the process of step S106.

On the basis of the determination result of the median strip determination unit 131, the progression direction estimation unit 132 estimates that the plurality of lanes LD in front of the median strip D in a case that viewed from the subject vehicle M among lanes included in the crossroad LC are lanes in the same progression direction, and estimates that the plurality of lanes LE behind the median strip D in a case that viewed from the subject vehicle M are lanes in a progression direction opposite to the progression direction of the plurality of lanes LD in front of the median strip (step S106).

The progression possibility determination unit 133 determines whether or not progression to the plurality of lanes LD and LE included in the crossroad LC is possible on the basis of the determination result of the progression direction estimation unit 132 (step S108).

The action plan generation unit 140 generates a target trajectory to a lane on which the vehicle is to travel for right turn or left turn on the basis of a result of the determination of the progression possibility determination unit 133 (step S110).

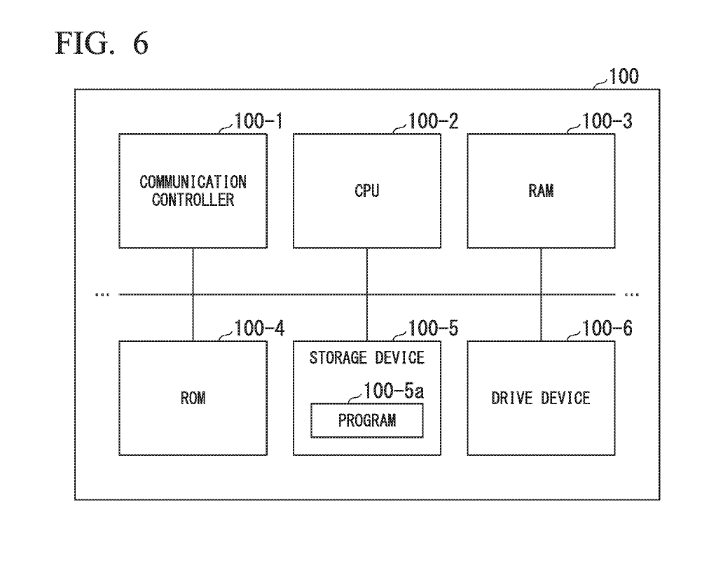

Hereinafter, a hardware aspect of the embodiment will be described. FIG. 6 is a diagram illustrating an example of a hardware configuration of the automatic driving control device 100. The automatic driving control device 100 includes, for example, a communication controller 100-1, a CPU 100-2, a RAM 100-3 used as a working memory, a ROM 100-4 that stores a boot program or the like, a storage device 100-5 such as a flash memory and an HDD, and a drive device 100-6, which are connected to each other via an internal bus or a dedicated communication line.

The communication controller 100-1 performs communication with a component other than the automatic driving control device 100 illustrated in FIG. 1. A program 100-5a to be executed by the CPU 100-2 is stored in the storage device 100-5. This program is developed in the RAM 100-3 by a direct memory access (DMA) controller (not illustrated) or the like and executed by the CPU 100-2. Accordingly, some or all of the median strip determination unit 131, the progression direction estimation unit 132, and the progression possibility determination unit 133 are realized.

The above-described embodiment can be represented as follows.

A surroundings monitoring device includes

a hardware processor, and

a storage device that stores a program,

wherein the hardware processor is configured to execute the program stored in the storage device

to thereby determine whether or not there is a median strip in a road around a vehicle, and

estimate that a plurality of lanes in front of the median strip in a case that viewed from the vehicle among lanes included in a crossroad in a case that the vehicle reaches the crossroad crossing the road on which the vehicle is traveling and it is determined that there is the median strip in the crossroad.

According to the above-described embodiment, the automatic driving control device 100 can easily estimate the progression direction of the plurality of lanes crossing at the crossing by detecting the median strip D. The automatic driving control device 100 can recognize section of the median strip D at the crossing and determine the progression direction of the plurality of lanes at the crossing separated by the median strip D and can prevent the subject vehicle M from reversely traveling on the lane.

Although a mode for carrying out the present invention has been described above using the embodiment, the present invention is not limited to the embodiment at all, and various modifications and substitutions may be made without departing from the spirit of the present invention.

What is claimed is:

1. A surroundings monitoring device, comprising:
a median strip determination unit that determines whether or not there is a median strip in a road near a vehicle; and
a progression direction estimation unit that estimates that a plurality of lanes in front of the median strip in a case that viewed from the vehicle among lanes included in a crossroad crossing a road on which the vehicle is traveling are lanes in the same progression direction in a case that the vehicle reaches the crossroad and the median strip determination unit determines that there is the median strip in the crossroad.

2. The surroundings monitoring device according to claim 1,
wherein the median strip determination unit further determines whether or not there is a section of the median strip of the crossroad in front of the vehicle, and
the surroundings monitoring device further comprises a progression possibility determination unit that determines that progression in a direction opposite to the same progression direction in the crossroad behind the median strip is possible in a case that the median strip determination unit determines that there is a section of the median strip of the crossroad in front of the vehicle.

3. The surroundings monitoring device according to claim 1,
wherein the median strip determination unit further determines whether or not there is a section of the median strip of the crossroad front of the vehicle, and
the surroundings monitoring device further comprises a progression possibility determination unit that determines that progression in the same progression direction in the crossroad in front of the median strip is possible in a case that the median strip determination unit determines that there is a section of the median strip of the crossroad in front of the vehicle.

4. The surroundings monitoring device according to claim 2, wherein the median strip determination unit determines that there is a section of the median strip in a case that the median strip determination unit recognizes two end portions of the median strip that are spaced a predetermined distance or more from each other.

5. The surroundings monitoring device according to claim 4, wherein the median strip determination unit determines that there is a section of the median strip in a case that the distance between the two end portions is equal to or greater than a width of a vehicle serving as a reference.

6. The surroundings monitoring device according to claim 1, wherein the progression direction estimation unit increases certainty that the plurality of lanes in front of the median strip in a case that viewed from the vehicle are lanes in the same progression direction on the basis of the progression direction of other vehicles traveling in the plurality of lanes in front of the median strip in a case that viewed from the vehicle.

7. A surroundings monitoring method that is executed by a computer mounted in a vehicle, the surroundings monitoring method comprising:
determining whether or not there is a median strip in a road near a vehicle; and
estimating that a plurality of lanes in front of the median strip in a case that viewed from the vehicle among lanes included in a crossroad crossing a road on which the vehicle is traveling are lanes in the same progression direction in a case that the vehicle reaches the crossroad and it is determined that there is the median strip in the crossroad.

8. A computer-readable non-transitory storage medium storing a program, the program causing a computer installed in a vehicle to:
determine whether or not there is a median strip in a road near a vehicle; and
estimate that a plurality of lanes in front of the median strip in a case that viewed from the vehicle among lanes included in a crossroad crossing a road on which the vehicle is traveling are lanes in the same progression direction in a case that the vehicle reaches the crossroad and it is determined that there is the median strip in the crossroad.
